(19) United States
(12) Patent Application Publication
(10) Pub. No.: US 2023/0368169 A1
(43) Pub. Date: Nov. 16, 2023

(54) OPTIMIZATION OF CASH FLOW

(71) Applicant: Intuit Inc., Mountain View, CA (US)

(72) Inventors: Alexander ZICHAREVICH, Petach Tikva (IL); Ido Meir MINTZ, Tel Aviv (IL); Yair HORESH, Kfar-Saba (IL)

(73) Assignee: Intuit Inc., Mountain View, CA (US)

(21) Appl. No.: 17/742,086

(22) Filed: May 11, 2022

(51) Int. Cl. G06Q 20/14; G06Q 30/04

(52) U.S. Cl. CPC G06Q 20/14; G06Q 30/04

(57) ABSTRACT

Systems and methods of optimizing cash flow are disclosed. A system obtains bill information regarding a plurality of bills and invoice information regarding a plurality of invoices, and the system pairs one or more bills to one or more invoices. Pairing the one or more bills includes, for each bill, generating one or more potential pairs of the bill to an invoice. For each potential pair, the system calculates a matching score associated with the potential pair based on the bill information of the bill and the invoice information of the invoice, identifies a subset of potential pairs of the one or more potential pairs associated with a threshold matching score, and selects a pair of a paired invoice to the bill from the subset of potential pairs. The system generates instructions to automatically pay the one or more bills, with payment scheduled based on the pairings.

### TECHNICAL FIELD

This disclosure relates generally to the automatic optimization of cash flow, including operations to match bills with invoices in order to better predict ongoing cash flow for an entity.

### DESCRIPTION OF RELATED ART

A business' cash flow is vital to the continued operations of the business. For example, cash flow for a business may be used to pay certain bills as well as make additional debt payments, ensure sufficient funds exist for payroll, make capital expenditures, and so on. People make decisions regarding future operations of a business based on the business' future cash flow. As such, the business' cash flow may be predicted for some amount of time into the future. Based on such predictions, the owner of the business may, e.g., decide whether to pay specific bills (as well as make a debt payment, set aside additional funds for payroll, invest in a capital expenditure, and so on). Since such payment decisions are based on predictive cash flow, there is a need to optimize cash flow predictions in order to have reliable data on which such decisions are based.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a computer-implemented method for cash flow optimization. The method includes obtaining a bill information regarding a plurality of bills to be paid. The bill information includes a bill amount of each of the plurality of bills and a bill due date of each of the plurality of bills. The method also includes obtaining an invoice information regarding a plurality of invoices to be collected. The invoice information includes an invoice amount of each of the plurality of invoices and an invoice collection date of each of the plurality of bills. The method further includes pairing one or more bills of the plurality of bills to one or more invoices of the plurality of invoices. Pairing the one or more bills includes, for each bill of the one or more bills: generating one or more potential pairs of the bill to an invoice from the plurality of invoices; for each potential pair of the one or more potential pairs, calculating a matching score associated with the potential pair based on the bill information of the bill and the invoice information of the invoice; identifying a subset of potential pairs of the one or more potential pairs associated with a threshold matching score; and selecting a pair of a paired invoice to the bill from the subset of potential pairs. The method also includes generating instructions to automatically pay the one or more bills based on the pairing, wherein an automatic payment of each bill of the one or more bills is based on a collection on the paired invoice for the bill.

Another innovative aspect of the subject matter described in this disclosure can be implemented in a system for cash flow optimization. An example system includes one or more processors and a memory storing instructions that, when executed by the one or more processors, cause the system to perform operations. The operations include obtaining a bill information regarding a plurality of bills to be paid. The bill information includes a bill amount of each of the plurality of bills and a bill due date of each of the plurality of bills. The operations also include obtaining an invoice information regarding a plurality of invoices to be collected. The invoice information includes an invoice amount of each of the plurality of invoices and an invoice collection date of each of the plurality of bills. The operations further include pairing one or more bills of the plurality of bills to one or more invoices of the plurality of invoices. Pairing the one or more bills includes, for each bill of the one or more bills: generating one or more potential pairs of the bill to an invoice from the plurality of invoices; for each potential pair of the one or more potential pairs, calculating a matching score associated with the potential pair based on the bill information of the bill and the invoice information of the invoice; identifying a subset of potential pairs of the one or more potential pairs associated with a threshold matching score; and selecting a pair of a paired invoice to the bill from the subset of potential pairs. The operations also include generating instructions to automatically pay the one or more bills based on the pairing, wherein an automatic payment of each bill of the one or more bills is based on a collection on the paired invoice for the bill.

In some implementations, a machine learning (ML) model is used to generate the matching scores for pairs of invoices and bills. In addition, a matching optimization model (such as a model implementing the Hungarian algorithm) may be used to optimize the pairings of invoices to bills based on the matching scores. In some implementations, the pairings may be provided for display on a user interface, with a user to provide feedback or input regarding the pairings. Pairing the bills and invoices may be updated based on the user feedback or input.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example system for cash flow optimization, according to some implementations.

FIG. 2 shows an illustrative flow chart depicting an example operation for cash flow optimization, according to some implementations.

FIG. 3 shows an illustrative flow chart depicting an example operation for use of a machine learning (ML) model to generate matching scores, according to some implementations.

FIG. 4 shows an illustrative flow chart depicting an example operation for optimizing pairings of invoices to bills, according to some implementations.

FIG. 5 shows an illustrative flow chart depicting an example operation for interacting with a user regarding pairings of invoices to bills, according to some implementations.

FIG. 6A shows an example graphical user interface (GUI), according to some implementations.

FIG. 6B shows another example of the GUI in FIG. 6A, according to some implementations.

FIG. 6C shows another example of the GUI in FIG. 6A, according to some implementations.

Like numbers reference like elements throughout the drawings and specification.

### DETAILED DESCRIPTION

Implementations of the subject matter described in this disclosure may be used for the optimization of cash flow for an entity. In particular, systems and methods are described regarding the pairing of invoices to bills and the use of such pairings to instruct whether and when to pay specific bills for an entity. Generating the pairings may be based on matching scores, which may be generated by a machine learning (ML) model. The matching scores may then be used by a matching optimization model to generate optimized pairings of invoices to bills. Such pairings may be adjusted by a user, with any feedback provided by a user being used to update the ML model or other portions of the system to generate the optimized pairings of invoices to bills.

As used herein, an entity may refer to a business, an individual, or any organization that may provide invoices and receive bills. A bill is a record or other information regarding a payment that is due to another party. An invoice is a record or other information regarding a payment that is to be received for another party. For example, a lawncare business may provide invoices to customers using the business and may receive bills from a store that leases lawn equipment to the lawncare business. While many of the examples herein are with reference to small or medium businesses that may be managed by a single individual or a small group of individuals, the implementations described herein may be applied to any type of entity with invoices and bills.

In order for a business to be able to pay its bills, the business must have funds available to pay such bills. Therefore, keeping track of the business' cash flow is important in keeping track of available funds to be able to pay bills. In keeping track of a business' cash flow, the immediate cash flow of the business may be forecast in order to determine if immediate bills can be paid. For example, an individual may track the next three months of bills and invoices to make sure the amounts of the invoices (and likelihood such invoices are paid on time) cover the amounts of the bills.

One way of managing cash flow is to pair bills and invoices. For example, referring back to the lawncare business, an invoice to a specific home may be paired with a lease payment due to a store for a lawnmower. Pairing the invoice to the bill may be based on the due dates of both (such as the invoice being due a few days to a week before the bill) and the amounts of both (such as the invoice and the bill being for approximately the same amount of money). In pairing the invoice to the bill, the individual running the lawncare business may pay the bill once payment is received for the paired invoice. In this manner, when to pay bills is managed based on when money is received for outstanding invoices, ensuring sufficient cash flow to cover the bills while also not requiring additional management of due dates for bills. Each bill may be paired to an invoice as appropriate in order to manage cash flow and payment of bills.

Software or other computer-implemented technologies may be used by an individual to manage cash flow, including the pairing of bills and invoices. For example, Intuit® QuickBooks or QuickBooks Online (QBO) is a financial management tool that may allow an individual to pair bills and invoices in order to manage cash flow of a small or medium business. In this manner, a user may user a graphical user interface (GUI) of QBO to manually pair invoices to bills. And QBO keeps track of invoices being paid, QBO may indicate which bills are to be paid (or may automatically instruct such bills to be paid through another service, such as through Melio Payments Inc. or another fintech institution setup for the business) based on the user's pairings.

One problem with manual pairings generated by an individual is that the pairings may not be optimal for cash flow of the business. For example, a manual pairing may be made in error where the due date of the invoice is after the due date of the bill. In another example, an invoice with a low probability of being paid on time may be paired with a bill that has a large late payment charge. Another problem with manual pairings is that a user is required to continuously generate and update such pairings as new invoices and bills are received. As a business grows and the numbers of bills and invoices grows into the hundreds or thousands a month, a week, or even a day, generating and keeping track of manual pairing may be difficult or even impossible for an individual.

As such, there is a need to have pairings of invoices to bills automatically generated and optimized in order to optimize cash flow and without requiring constant oversight. As described herein, a system may automatically match invoices to bills, and the system may instruct when to pay such bills based on such pairings. The final pairs of invoices to bills may be based on a matching score generated by the system (with a matching score indicating the likelihood that a specific invoice is to be paired with a specific bill), and the system may optimize the pairings based on such matching scores. While the system may automatically generate pairings and instruct bills to be paid based on such pairings, the system may also allow a user to see and modify the pairings as the individual sees fit. In addition, the system may run iteratively such that whenever a new bill is received or a new invoice is generated, the system may update the pairings of invoices to bills to ensure that the pairings being used remain optimized. In some implementations, generation of the matching score is performed by a machine learning (ML) model. Use of a ML model may allow for the identification of specific patterns or other optimizations in pairing invoices to bills that would be overlooked in manually matching invoices to bills.

Various implementations of the subject matter disclosed herein provide one or more technical solutions to the technical problem of optimization of electronic datasets. Some implementations of the subject matter provide one or more technical solutions to automatic cash flow optimization of a business based on continuously incoming bills and generated invoices. In some implementations, a computing system is configured to obtain a bill information regarding a plurality of bills to be paid, where the bill information includes a bill amount of each of the plurality of bills and a bill due date of each of the plurality of bills. The computing system is also configured to obtain an invoice information regarding a plurality of invoices to be collected, where the invoice information includes an invoice amount of each of the plurality of invoices and an invoice collection date of each of the plurality of bills. The computing system is further configured to pair one or more bills of the plurality of bills to one or more invoices of the plurality of invoices. Pairing the one or more bills includes, for each bill of the one or more bills, generating one or more potential pairs of the bill to an invoice from the plurality of invoices. Pairing the one or more bills also includes, for each bill of the one or more bills and for each potential pair of the one or more potential pairs, calculating a matching score associated with the potential pair based on the bill information of the bill and the invoice information of the invoice. Pairing the one or more bills further includes, for each bill of the one or more bills, identifying a subset of potential pairs of the one or more potential pairs associated with a threshold matching score and selecting a pair of a paired invoice to the bill from the subset of potential pairs. The selected pairs may be considered to optimized pairs of invoices to bills. The computing system may also be configured to generate instructions to automatically pay the one or more bills based on the pairing. Automatic payment of a bill is based on a collection (receiving payment) on the paired invoice for the bill.

Various aspects of the present disclosure provide a unique computing solution to a unique computing problem that did not exist prior to the creation of electronic databases and electronic payment systems. Processing hundreds or thousands, or even millions, of invoices and bills daily to optimize pairings between the groups cannot be performed in the human mind, much less using pen and paper. In addition, machine learning technology being used and trained based on user feedback to further optimize pairings cannot be performed in the human mind, much less using pen and paper. As such, implementations of the subject matter disclosed herein are not an abstract idea such as organizing human activity or a mental process that can be performed in the human mind.

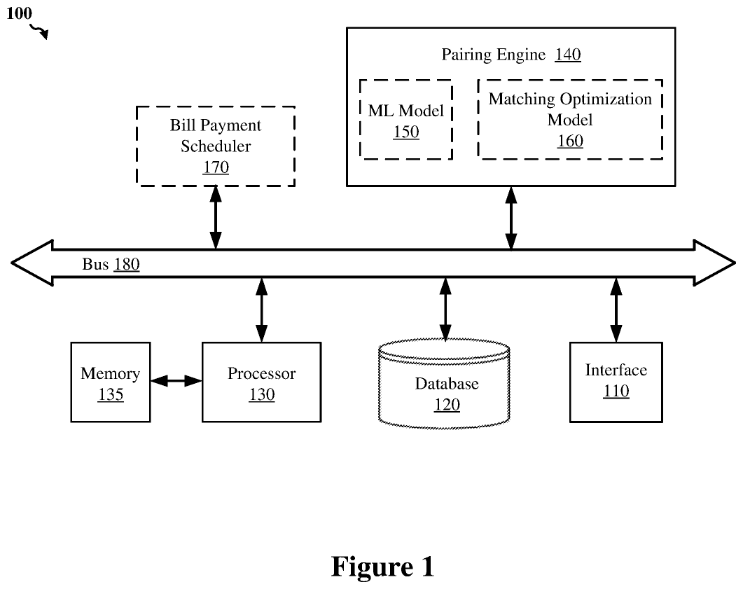

FIG. 1 shows an example system 100 for cash flow optimization, according to some implementations. The system 100 includes an interface 110, a database 120, a processor 130, a memory 135 coupled to the processor 130, and a pairing engine 140. The system 100 may also include a bill payment scheduler 170. In some implementations, the various components of the system 100 may be interconnected by at least a data bus 180, as depicted in the example of FIG. 1. In other implementations, the various components of the system 100 may be interconnected using other suitable signal routing resources.

The system 100 may host a service provided to a user. For example, the system 100 may be a remote system to a user to provide an online financial management service, such as QBO. The financial management service may be an application to keep track of bills received and invoices generated as well as bank account information and transactions for the business. In this manner, the system 100 may communicate with a user's local system through the internet or an intranet, and the user may interact with the service, such as via a web portal. Via a web portal, the user may generate new invoices, upload new bills, or request other operations be performed by the service. Alternatively, the system 100 may be a local system to the user, with the user interacting with a GUI on a display to upload a bill (such as via a scanner), generate an invoice, or request other operations be performed by the service. The system 100, whether remote or local, may also communicate with one or more financial institutions (such as one or more banks) or other entities on the user's behalf in order to receive information regarding new transactions (such as new bills generated or received by the institutions, payments received for outstanding invoices, and so on).

The interface 110 may be one or more input/output (I/O) interfaces to obtain bill information, invoice information, or other financial information regarding an entity. The interface 110 may also obtain user input or feedback, provide instructions for payment of one or more bills, provide an indication of pairings generated by the system 100, calls and responses to one or more financial institution systems or other systems, and so on for continued operation of the system 100. For example, the interface 110 may be used to connect with a financial institution every night in order to receive the transactions executed for that day (including payments and collections). As used herein, a payment is money from the entity to satisfy a bill, and a collection is money to the entity to satisfy an invoice.

An example interface may include a wired interface or wireless interface to the internet or other means to communicably couple with other devices. For example, the interface 110 may include an interface with an ethernet cable or a wireless interface to a modem, which is used to communicate with an internet service provider (ISP) directing traffic to and from user devices (such as a user's personal computer). As used herein, a “user” may refer to an individual or collection of individuals (which may perform actions on an entity's behalf or may be the entity itself). For example, if the entity is a small business, a user may refer to the business owner, an employee of the business, or another agent of the business.

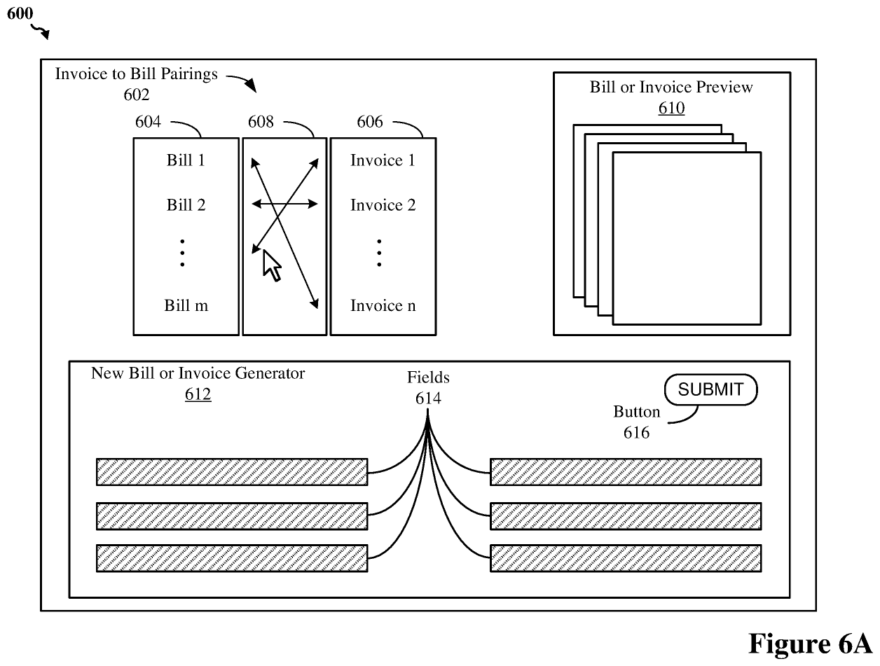

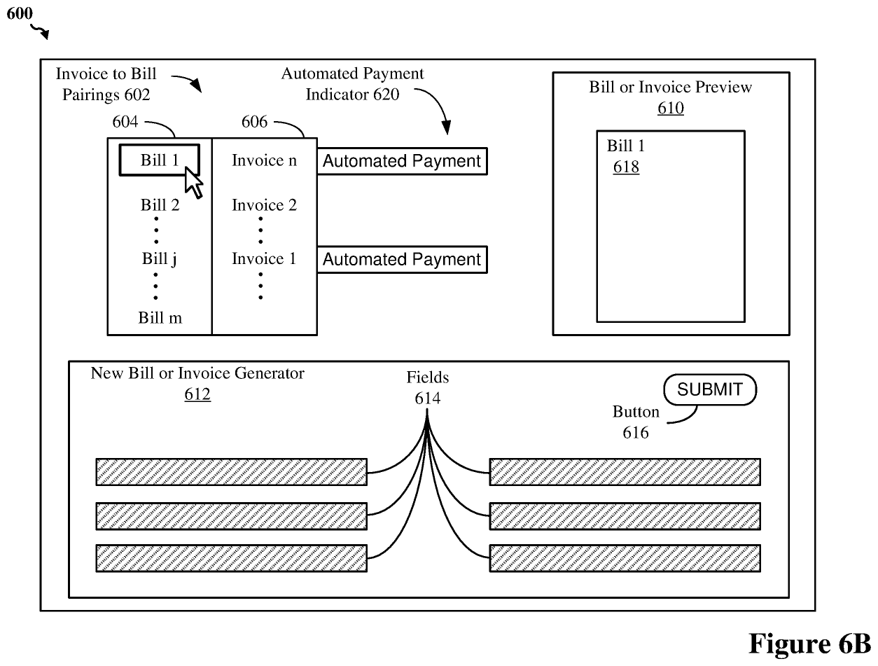

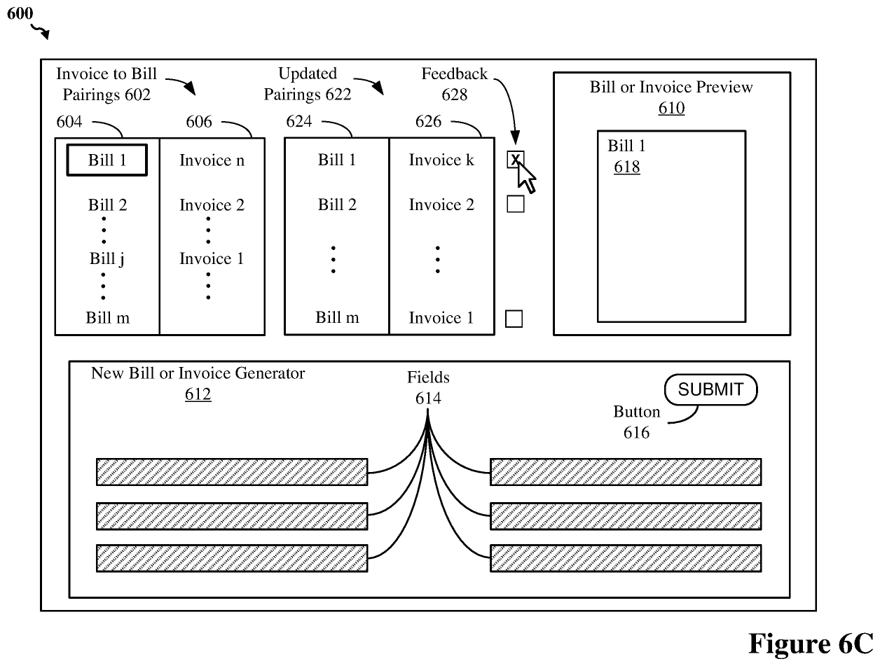

As noted above, the system 100 is configured to generate pairings of invoices and bills and generate instructions for the payments of such bills based on the collections of the paired invoices. Such instructions may be transmitted via the interface 110 to another device (such as at a fintech institution to perform payment of the bill). In addition, if the system 100 is remote, an indication of such pairings may be transmitted via the interface 110 to a user device. The interface 110 may also receive user input of feedback from the user device. If the system 100 is local, the interface 110 may include a display (which may include a touch sensitive display), a speaker, a mouse, a keyboard, or other suitable input or output elements that allow interfacing with the user. In this manner, the system 100 may display the pairings on a graphical user interface (GUI), allowing the user to provide input or feedback regarding the pairings. The GUI may also be used by a user to generate an invoice or input a bill. An example GUI is described in more detail below with reference to FIGS. 6A-6C.

The database 120 may store bill information and invoice information obtained by the interface 110. The bill information is for a plurality of bills, and the bill information includes at least the bill amount and the bill due date of each of the plurality of bills. For example, the interface 110 may receive bill information nightly from one or more financial institutions and/or on demand by a user importing one or more bills, and the database 120 may store the bill amount and bill due date of each of the plurality of bills for which bill information is received. In some implementations, the bill information may also include the potential late payment fee for the bill (which may also include a grace period). The bill information may also include the type or priority of bill, such as whether the bill pertains to an item that must be paid for continuation of the business (such as utilities, rent, etc.) or the bill pertains to more optional items (such as subscriptions, cable television, etc.).

The invoice information is for a plurality of invoices, and the invoice information includes at least the invoice amount and the invoice collection date of each of the plurality of invoices. For example, the interface 110 may receive invoice information for invoices generated by the user using a GUI for a service provide by the system 100, and the database 120 may store the invoice amount and the invoice collection date. In some implementations, the invoice collection date is the due date of the invoice. In some other implementations, the invoice collection date may be the likely date that an invoice is paid. For example, if a customer always pays an invoice a week before the invoice due date, the invoice collection date may be a week before the invoice due date. The invoice collection date may be automatically set by the system 100 (such as the invoice due date) or may be manually set by a user (such as a date selected by the user other than the invoice due date). The invoice information may also include an invoice late payment fee if the collection is after an invoice due date and/or an invoice payment probability. An invoice payment probability may be a probability assigned to the specific invoice that the invoice is to be paid on time (or at all). For example, existing customers may have a 99 percent probability of paying invoices on time, but new customers may have an 85 percent probability of paying invoices on time. In some implementations, additional bill and invoice information (such as payment fees, types of bills, invoice payment probabilities, etc.) may be used to generate matching scores or otherwise generate pairings of invoices to bills.

The database 120 may also store pairings generated by the system 100 and user input or feedback regarding the pairings. The database 120 may further store instructions for paying one or more bills, instructions regarding a pairing engine 140 (such as a ML model 150 or a matching optimization model 160) or a bill payment scheduler 170, or other computer executable instructions for operation of the system 100. In some implementations, the database 120 may include a relational database capable of presenting information (such as invoice information, bill information, and pairings between bills and invoices) as data sets in tabular form and capable of manipulating the data sets using relational operators. The database 120 may use Structured Query Language (SQL) for querying and maintaining the database 120.

The processor 130 may include one or more suitable processors capable of executing scripts or instructions of one or more software programs stored in system 100 (such as within the memory 135). For example, the processor 130 may be capable of executing one or more applications, the pairing engine 140 (which may include an ML model 150 and a matching optimization model 160), or the optional bill payment scheduler 170. The processor 130 may include a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the processors 130 may include a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the processor 130 to perform one or more corresponding operations or functions. For example, the memory 135 may store the one or more applications, the pairing engine 140, or the bill payment scheduler 170 that may be executed by the processor 130. The memory 135 may also store the bill information or invoice information, the pairings generated by the pairing engine 140, matching scores generated by the pairing engine 140, user input or feedback regarding the pairings, instructions for paying one or more bills generated by the bill payment scheduler 170, or any other data for operation of the components 140-170. In some implementations, hardwired circuitry may be used in place of, or in combination with, software instructions to implement aspects of the disclosure. As such, implementations of the subject matter disclosed herein are not limited to any specific combination of hardware circuitry and/or software.

The pairing engine 140 generates pairings of one or more bills to one or more invoices based on the bill information and the invoice information. In some implementations, the pairing engine 140 attempts to pair each bill with an invoice. For example, the pairing engine 140 attempts to pair a bill an invoice with a similar bill due date and invoice collection date (e.g., within a threshold amount of time, such as 3 days) and with similar amounts (e.g., the bill amount being within a threshold amount of the invoice amount, such as within 10 dollars, 5 percent, or another suitable threshold). In some implementations, the pairing engine 140 may also pair a bill with an invoice based on the bill having a higher late payment fee and the invoice having a higher probability of being collected. For the pairing engine 140 to pair invoices and bills, for each bill, the pairing engine 140 generates a matching score for a plurality of potential pairs of invoices to the bill based on the bill information and the invoice information for the potential pair. The matching scores may then be used to optimize which invoice is to be paired to which bill in generating the optimized pairings. As new bills or invoices are obtained, the matching scores may be recalculated and pairings updated based on the new matching scores. As invoices are collected and bills are paid, the corresponding pairs may be removed from the pairings. Calculating matching scores may be performed in any suitable manner, with example implementations described below. For example, the matching scores may be generated by an ML model 150 trained to generate matching scores for potential one-to-one pairs of invoices and bills.

The ML model 150 may be any suitable ML classification model and may be based, e.g., on one or more of decision trees, gradient boosted trees, random forests, or other classification trees. In some implementations, the ML classification model is a gradient boosted tree model. For example, the XGBoost software library may be used to generate the ML classification model configured to generate matching scores. A matching score may be any suitable metric, such as a percentage, a decimal from zero to one, a fraction, or a number on any suitable range. While the ML model is described herein as being an ML classification model, the ML model may be any suitable ML model, which may be based on, e.g., any of the classification models listed above, logistic regression, nearest neighbors, control flow graphs, support vector machines, naïve Bayes, Bayesian Networks, value sets, hidden Markov models, or neural networks configured to generate matching scores.

The system 100 may train the ML model 150, such as via supervised learning. For example, the ML model 150 may receive the bill information and the invoice information and generate a matching score for each potential pair of bill and invoice. A user may receive an indication of the potential pairs and provide feedback regarding which pairs may be desirable. The user feedback may be used as labels to validate the matching scores in order to cause the ML model 150 to boost the matching score for desirable pairings while decreasing the matching score for undesirable pairings. Additionally or alternatively, an ML classification model may generate a set of pairings (based on matching scores). User feedback may be received regarding the set of pairings, and the ML classification model may be iteratively updated based on the user feedback. After enough user feedback is received, the ML model 150 may be sufficiently trained to be used to generate the final pairings of bills and invoices. In some implementations, before the ML model 150 is sufficiently trained, the pairing engine 140 may use a statistical model or any other suitable means of generating pairings to be used.

The pairing engine 140 may also include a matching optimization model 160 to generate optimized pairings of bills and invoices based on the matching scores. The matching optimization model 160 may be any suitable model to select one-to-one pairings based on a metric generated for each potential one-to-one pairing. In some implementations, the matching optimization model 160 implements the Hungarian model for optimizing pairings, with the optimization being treated as a linear sum assignment problem (LSAP). While the Hungarian model is depicted as an example model used to generate the optimized pairings, any suitable combinatorial optimization model for the pairings may be used. In this manner, the ML model 150 may generate the matching scores for all potential pairs, which are provided to the matching optimization model 160. The matching optimization model 160 may generate the optimized pairings based on the matching scores for all potential pairs. If the pairs or matching scores are indicated to a user with feedback received, the system 100 may update the ML model 150 to adjust the matching scores to cause the matching optimization model 160 to generate updated pairings in line with the user feedback. For example, the user may adjust one or more pairs, may indicate one or more pairs as undesirable, or otherwise may indicate that the pairings are to be adjusted. Such feedback may then be used to adjust the ML model 150. Additionally or alternatively, the matching optimization model 160 may be adjusted based on the user feedback. For example, if a user indicates one or more pairings not previous selected by the model 160 that are to be used, the matching optimization model 160 may be updated to remove the invoices and bills of the selected pairs from being part of the combinatorial optimization problem (with such pairs already being fixed for the final pairings generated by the system 100).

Based on the final pairings, the system 100 may be configured to generate instructions to automatically pay one or more bills based on the pairings. For example, the system 100 may include a bill payment scheduler 170 to generate instructions to pay a bill based on payment for the paired invoice being received. The system 100 may transmit the instructions to pay the bill (such as via the interface 110) to a financial institution (such as a bank or fintech payment service) so that payment may be made for the bill. In some other implementations, the system 100 may instruct a user to pay the bill, such as by instructing a notification to be displayed on the user's device with the information to be used in generating the payment (such as information used for writing a check and filling out an envelope for mailing said check). To note, one or more bills or one or more invoices may not be included in the potential pairings. For example, a user may indicate one or more bills (such as a high priority bill) to not be included in the pairing, with the user to personally handle payment of such bills. As used herein, all potential pairings may refer to all potential bills and invoices being paired but excluding those bills or invoices indicated as not to be included in the cash flow optimization process.

While the pairing engine 140 (which may include the ML model 150 and the matching optimization model 160) and the optional bill payment scheduler 170 are depicted as separate components of the system 100 in FIG. 1, the components 140-170 may be a single component, may include additional components, may include software including instructions stored in memory 135 or the database 120, may include application specific hardware (e.g., one or more ASICs), or a combination of the above. As such, the particular architecture of the system 100 shown in FIG. 1 is but one example of a variety of different architectures within which aspects of the present disclosure may be implemented. For example, in other implementations, components of the system 100 may be distributed across multiple devices, may be included in fewer components, and so on. While the examples herein are described with reference to system 100, any suitable system may be used to perform the operations described herein.

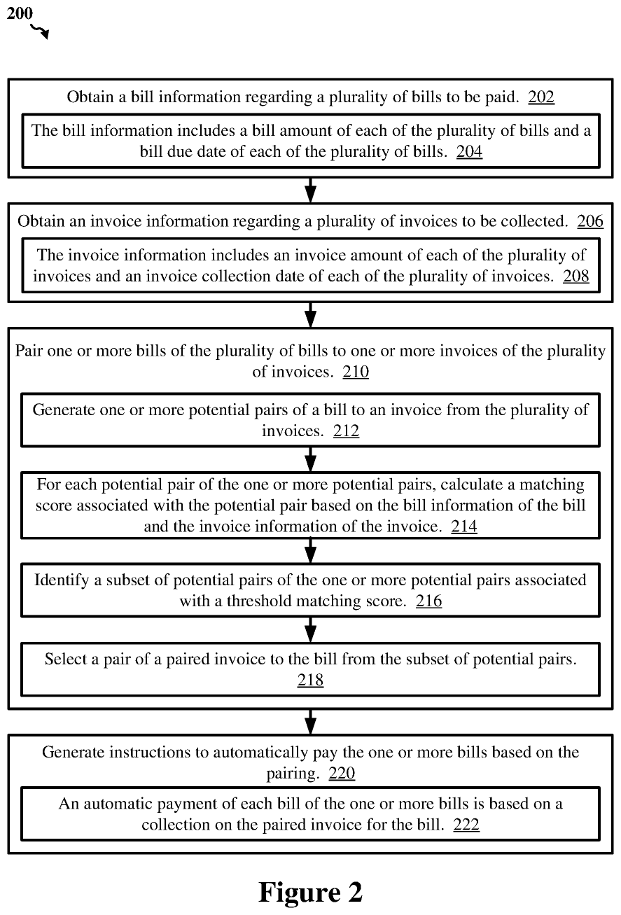

FIG. 2 shows an illustrative flow chart depicting an example operation 200 for cash flow optimization, according to some implementations. The example operation 200 is described as being performed by the system 100 for clarity, but any suitable system may be used to perform the example operation 200. For cash flow optimization, the system 100 is to pair bills to invoices and automate the timing of payments of bills based on the collections of invoices.

At 202, the system 100 obtains a bill information regarding a plurality of bills to be paid. The bill information includes a bill amount and a bill due date of each of the plurality of bills (204). In some implementations, the system 100 obtains bill information for bills uploaded by a user. Obtaining such bill information may be on demand as the bills are uploaded. For example, a user may scan a paper bill or may input information regarding a bill mailed to the user using a GUI of QBO or another financial management service. If the service is remotely provided (such as via the web portal), the interface 110 may include a wired or wireless connection to the internet to receive the bill information from a user device. If the service is locally provided, the interface 110 may include a display and one or more input devices to interact with a user via a GUI for the user to input the bill information. In another example, an electronic bill may be automatically obtained by the system 100 from a financial institution issuing the bill. Additionally or alternatively, some bills may be previously indicated as recurring. For example, a user may previously indicate that rent is to occur monthly for the same amount over the term of a lease. Obtaining bill information for such as recurring bill may refer to identifying the bill information for each monthly rent bill (such as the rent being due on the first of the month for a defined amount).

At 206, the system 100 obtains an invoice information regarding a plurality of invoices to be collected. The invoice information includes an invoice amount and an invoice collection date of each of the plurality of invoices (208). In some implementations, the system 100 obtains invoice information for invoices generated by the user (such as from a user device via the internet for a remotely provided service or from one or more input devices of the interface 110 for a locally provided service). Obtaining the invoice information may be on demand as invoices are generated. For some invoices, the invoices may be automatically generated as recurring. For example, referring back to a lawncare business, a customer may have a service contract for which the business provides lawncare service every week for the home. The lawncare business may provide an invoice to the customer weekly or monthly for an agreed upon rate. Such invoices may be automatically generated, with the invoice information being obtained when the invoice is automatically generated.

Obtaining bill information and invoice information may be for any suitable time period. For example, such information may be obtained for the next three months (or another suitable time period). In this manner, bill information regarding rent bills for the next three months may be obtained, but bill information for a tax bill due in nine months may not be obtained. In another example, bill information and invoice information may be obtained for all bills and invoices that are still outstanding.

While example bill information is indicated as including a bill due date and a bill amount, bill information may include any suitable information to be used to pair bills and invoices. Similarly, while example invoice information is indicated as including an invoice collection date (which may be an invoice due date, a predicted date on which payment is received, or another suitable date) and an invoice amount, invoice information may include any suitable information to be used to pair bills and invoices. In some implementations, the bill information and/or the invoice information may include one or more of an invoice payment probability, a bill late payment fee that would be levied by the financial institution if the entity provides payment after the bill due date, and an invoice late payment fee that would be levied by the entity if payment from a customer or another is received after the invoice due date. In some implementations, the additional information may also include the invoice due date if the invoice collection date is a date other than the invoice due date. As described herein, the calculation of matching scores for potential pairs of bills and invoices may be based on the additional information.

In some implementations, such additional information may be obtained when obtaining the bill due date, the bill amount, the invoice collection date, and the invoice amount (such as when a bill is uploaded or when an invoice is generated). In some implementations, some of the additional information may be predefined. For example, the system 100 may have predefined that an invoice late payment fee is 25 dollars. Obtaining the invoice late payment may refer to the predefined late payment fee being associated with the other invoice information for a newly generated invoice. For example, a user may generate a new invoice using a GUI of QBO, and the system 100 (or a user system) may generate an electronic record, object, or file with the invoice due date and the invoice amount. The system 100 (or the user system) may also include the predefined invoice late payment fee in the electronic record for the invoice. To note, the record may be embodied in a JavaScript Object Notation (JSON) object or another computer readable object. The object may be provided and stored in the database 120. In this manner, the database 120 may include records for each bill and invoice. Alternatively, a single record including all of the bills and/or all of the invoices may be stored in the database (such as one or more tables listing the totality of invoices and/or bills with entries for the invoice information and bill information).

At 210, the system 100 (such as the pairing engine 140) pairs one or more bills of the plurality of bills to one or more invoices of the plurality of invoices. In pairing one or more bills to one or more invoices, the system 100 generates an optimized one-to-one pairing of a bill to an invoice, with optimization being based on the bill information and the invoice information. In pairing one or more bills to one or more invoices, the pairing engine 140 generates one or more potential pairs of a bill to an invoice from the plurality of invoices (212). In some implementations, the pairing engine 140 generates each potential pair of bills and invoices In a simplified example, if there are 100 bills and 100 invoices, the pairing engine 140 may generate 10,000 potential pairs of a bill to an invoice.

While not depicted in FIG. 2, the system 100 may prevent one or more bills or one or more invoices from being included in the automatic pairing. In some implementations, the system 100 may exclude bills over a threshold bill amount and/or invoices over a threshold invoice amount from being included in the automatic pairing. For example, bills over a threshold amount (such as more than 5,000 dollars) may cause a large capital outflow from a bank account. As such, an individual may desire to be aware when such bill is to be paid (or to pay the bill himself or herself). The bill may thus be excluded from the potential pairs and subsequent automatic payment of bills based on final pairs selected from the potential pairs. Other types of bills or invoices that may be excluded may include invoices with a low collection probability or bills or invoices identified by a user as to be excluded.

With the potential pairs generated, the pairing engine 140 calculates, for each potential pair, a matching score associated with the potential pair based on the bill information of the bill and the invoice information of the invoice for the potential pair (214). In some implementations, calculating a matching score based on the bill information of the bill and the invoice information of the invoice is based on a combination of: (i) a difference in the bill amount of the bill and the invoice amount of the invoice and (ii) a difference in the bill due date of the bill and the invoice collection date of the invoice. Any suitable calculation of a matching score using the difference in amounts and the difference in the dates may be used. For example, the system 100 may generate a matching score of zero for each potential pair if the difference in dates is greater than two weeks. The system 100 may then generate the matching score for each remaining potential pair as the bill amount divided by the difference in amounts. In another example, a first loss function may be defined for the difference in dates, and a second loss function may be defined for the difference in amounts. In this manner, the system 100 may generate a first loss value using the first loss function and a second loss value using the second loss function. The matching score may thus be a combination of the first loss value and the second loss value. For example, if the first loss value and the second loss value are normalized from 0 to 1 (with 0 indicating no match and 1 indicating the best possible match), the matching score may equal multiplying the first loss value and the second loss value. To note, the loss functions may be any suitable functions. In another example, a combined loss function may be used to generate a matching score. In some implementations, the loss function or functions may be based on a regression model or another suitable statistical model. In addition or alternative to use of a statistical model, in some implementations, the pairing engine 140 may include an ML model 150 to generate the matching scores.

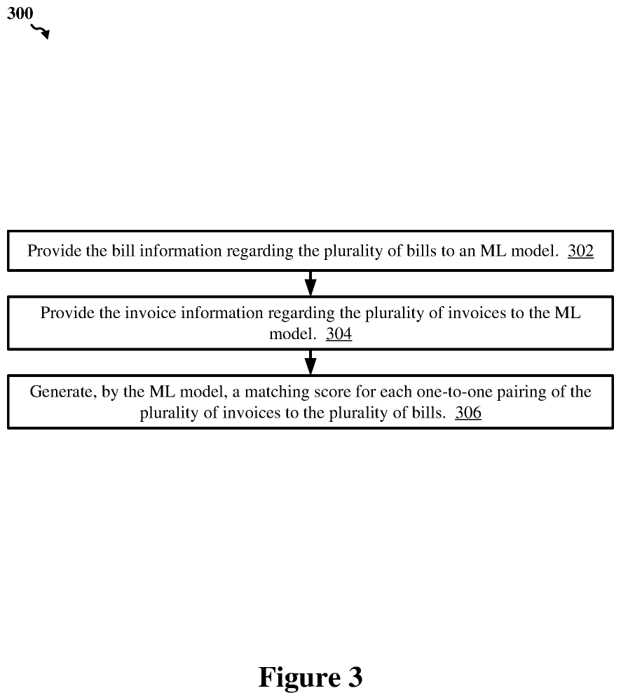

FIG. 3 shows an illustrative flow chart depicting an example operation 300 for use of an ML model 150 to generate matching scores, according to some implementations. At 302, the system 100 provides the bill information regarding the plurality of bills to the ML model 150. For example, the bill due dates and associated bill amounts may be a first set of inputs to the ML model 150. At 304, the system 100 also provides the invoice information regarding the plurality of invoices to the ML model 150. For example, the invoice collection dates and associated invoice amounts may be a second set of inputs to the ML model 150 In some implementations, additional information may be provided to the ML model 150, such as invoice collection probabilities or late payment fees. At 306, the ML model 150 generates a matching score for each one-to-one pairing of the plurality of invoices to the plurality of bills. As noted above, any suitable ML model may be used by the system 100. In some implementations, the ML model 150 may use a combined loss function in which the difference in dates is a first loss value and the difference in amounts is a second loss function. In this manner, the ML model 150 may attempt to minimize the first loss value and the second loss value in an attempt to identify the optimized pairings.

In some implementations, the ML model 150 may be trained using such a loss function. In some implementations, the ML model 150 may be trained based on user feedback regarding matching scores or suggested pairings based on the matching scores. Supervised learning based on user feedback may be based on the matching scores being indicated to a user, and the user indicating one or more desired pairings in response to the matching scores. For example, for each bill or for each invoice, the system 100 may provide an indication of the top five matching scores and associated potential pairs to be indicated to the user. Such indication may be provided via a GUI, and the user may select the desired pair from the five presented pairs. The selection of pairs by the user may be used as labels that are fed back into the ML model 150 in order to adjust the ML model 150 to generate higher matching scores for the selected pairs and lower matching scores for one or more potential pairs that are not selected. With enough potential pairs being accepted or rejected by a user (or by a plurality of users), the ML model 150 may be sufficiently trained to generate matching scores to be used for the pairing of bills and invoices. In some implementations, ML model training may include random forest regression or logistic regression.

Referring back to FIG. 2, with the matching scores generated by the pairing engine 140 (such as by the ML model 150, a statistical model, or in another suitable manner), the pairing engine 140 identifies a subset of potential pairs of the one or more potential pairs associated with a threshold matching score (216). For example, a threshold matching score may indicate a minimum score for a pair to be considered an acceptable match between bill and invoice. The system 100 may not use a potential pair in the final set of pairings if the potential pair's matching score is less than the threshold. In some implementations, the threshold matching score is the average matching score for a simulation of pairings of all invoices and bills accumulated during a week (or another suitable period of time). The system 100 may generate all matching scores for all potential pairs of bills and invoices obtained over the week and average the matching scores. The average matching score may then be used to filter out potential pairs with lower matching scores from being used for the final pairings of invoices and bills. The average matching score for one week may be used as the threshold matching score for any suitable amount of time (such as for just the week, for a number of weeks, for a month, etc.). In some implementations, the average matching score may be periodically calculated (such as every week or every month). In some other implementations, the average matching score may be recalculated upon request by the user. While an average matching score is described as being the threshold matching score, the threshold may be any suitable value, and may be predefined, user adjustable, or otherwise set.

A threshold matching score may ensure that a sufficient number of bills and invoices exist in order to accurately use pairings of bills and invoices in order to automate payment of bills and optimize cash flow. For example, the system 100 is desired to be operational as soon as possible to offload management of bill payments from a user, but if too few of bills and invoices exist, the pairings used may be suboptimal to cause issues with automatic bill payment. For example, a bill due date may be too long before an invoice collection date such that payment of the bill may be after the bill due date to cause late fees or to make the account delinquent. In another example, the bill amount may be so much more than the paired invoice amount that the bank account used to pay the bill and receive the collection may have a large capital outflow. If the capital outflow is too large, the bank account may be overdrawn. As such, the threshold matching score may be a safeguard to ensure that no pairs with low matching scores are used to manage bill payments. As the number of invoices and the number of bills increase, the probability that at least one potential pair with a sufficient matching score exists increases. In performing block 216, for each bill, the system 100 may identify a subset of potential pairs associated with a threshold matching score (e.g., the matching score of each potential pair in the subset being greater than the threshold matching score). To note, for some bills, no matching scores of the potential pairs may be greater than the threshold matching score. As a result, the subset of potential pairs identified for a bill may be a null subset including no potential pairs. As such, the bill may remain unpaired.

At 218, for each bill, the pairing engine 140 (such as the matching optimization model 160) may attempt to select a pair of a paired invoice to the bill from the subset of potential pairs. The selected pairs across all of the bills may be considered the optimized pairings. In some instances, a bill may not be paired to an invoice in the optimized pairings, and the bill may be handled manually or separately from the bills included in the optimized pairings. Selecting the potential pairs to be included in the optimized pairings may be performed in any suitable manner. In some implementations, the pairing engine 140 selects the highest matching scores until all of the bills are paired or until the threshold matching score is reached. For example, the overall highest matching score may be associated with a first potential pair of a first bill and a first invoice. The system 100 may identify the first potential pair as being included in the optimized pairings. The system 100 then moves on to a potential pair having the next highest matching score. If a bill of the next matching score is already included in one of the selected pairs for the optimized pairings, the system 100 may skip the potential pair and go on to the next potential pair with the next highest matching score.

While the above example is a simplified example of generating the optimized pairings based on the highest matching scores, the matching optimization model 160 may be implemented to optimize the final pairings in any suitable manner. In some implementations, determining the optimum pairings based on the matching scores may be treated as a linear sum assignment problem (LSAP). For example, the matching optimization model 160 may implement any suitable means to solve such an LSAP to pair the bills to invoices that maximizes the sum of the matching scores associated with the selected pairs of the optimized pairings. In some implementations, the optimization problem may be treated as an unbalanced minimal sum assignment problem. To note, the problem may be considered unbalanced because the number of invoices probably does not equal to the number of bills. As such, there may not be a solution that pairs all bills and all invoices in one-to-one pairings.

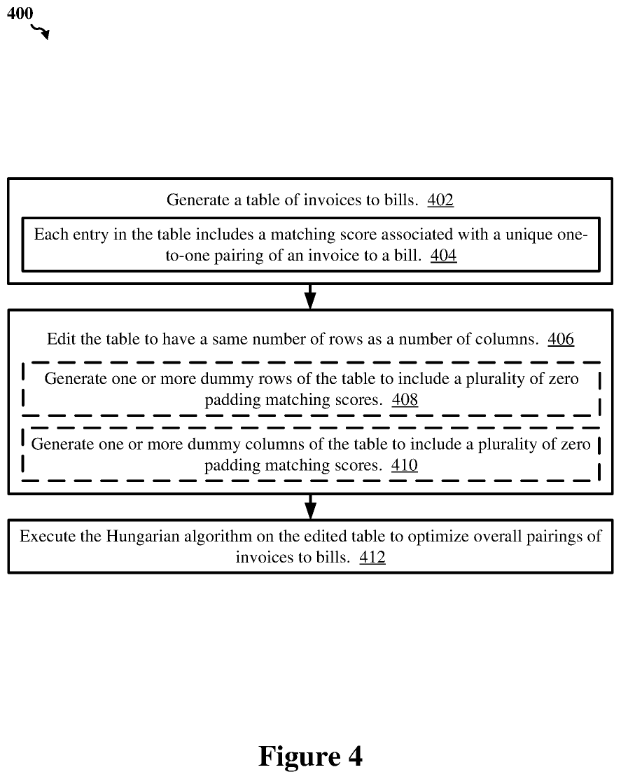

FIG. 4 shows an illustrative flow chart depicting an example operation 400 for optimizing pairings of invoices to bills, according to some implementations. The operation 400 may be performed by the system 100 (such as the matching optimization model 160 implemented to perform the Hungarian algorithm (or another suitable algorithm) for solving the unbalanced minimal sum assignment problem) to optimize the overall pairings of invoices to bills. To note, the matching scores to be used may be obtained from the ML model 150 or in any other suitable manner. In this manner, pairing the one or more bills includes executing a matching optimization model to optimize overall pairings of invoices to bills based on the matching scores generated by the ML model 150 for all of the one-to-one pairings of the plurality of invoices to the plurality of bills. At 402, the system 100 generates a table of invoices to bills. For example, the rows of the table may correspond to bills, and the columns of the table may correspond to invoices (or vice versa). In generating the table, the matching scores of corresponding bills and invoices is entered into the entries of the table. In this manner, each entry in the table includes a matching score associated with a unique one-to-one pairing of an invoice to a bill (404). For example, if the first row of the table is associated with a first bill and the first column of the table is associated with a first invoice, the entry at row 1, column 1 of the table is to include the matching score calculated for the potential pair of the first bill and the first invoice.

Since the number of bills may not equal the number of columns, the number of rows may not equal the number of columns. At 406, the system 100 edits the table to have a same number of rows as a number of columns. In some implementations, if the table has more columns than rows, the system 100 generates one or more dummy rows of the table to include a plurality of zero padding matching scores (408). A zero padding matching score may refer to a matching score of zero or another value to indicate that the pairing is a dummy pairing based on a nonexistent bill or a nonexistent invoice. If the zero padding matching score is zero, the entries of the one or more dummy rows for each column is zero. If the table has more rows than columns, the system 100 may generate one or more dummy columns of the table to include a plurality of zero padding matching scores (410). If the zero padding matching score is zero, the entries of the one or more dummy columns for each row is zero. In this manner, the edited table includes the same number of rows and columns in order to pretend that the same number of bills and invoices exist for the optimization problem.

At 412, the system 100 executes the Hungarian algorithm on the edited table to optimize overall pairings of invoice to bills. In this manner, the system 100 may generate an optimized set of one-to-one pairings of bills and invoices. The optimized pairings may be the final pairings used to automate payment of the bills or may be indicated to a user (who may adjust the pairings or otherwise provide feedback for the pairings to be adjusted). In some implementations, the system 100 may indicate the pairings. For example, if the user is local, the system 100 may display the pairings via a GUI. If the user is remote, the system 100 may transmit an indication of the pairings to a user device that displays the pairings via a GUI. The system 100 may receive user feedback (such as via the GUI for a local user or from a user device via a wired or wireless interface for a remote user) regarding the pairings. For example, the user may accept or reject some pairs and/or change some pairs via a GUI. Referring back to FIG. 2, selecting the pair of the paired invoice to the bill (218) may be based on the feedback. For example, if a pair is rejected, the Hungarian algorithm may be executed again with the rejected pair being excluded from being selected. Additionally or alternatively, the ML model 150 may be adjusted to adjust the matching score associated with the rejected pair (such as being used as a label in supervised learning). In another example, an accepted pair or a pair adjusted by the user may cause the Hungarian algorithm to be executed again with the row and column associated with the accepted pair being removed or otherwise excluded from the table of bills and invoices. Additionally or alternatively, the ML model 150 may be adjusted to adjust the matching score associated with the accepted pair. While some examples are provided of adjusting the selection of pairs, feedback may be used in any suitable manner for the final selection of pairs for the optimized pairings to be used.

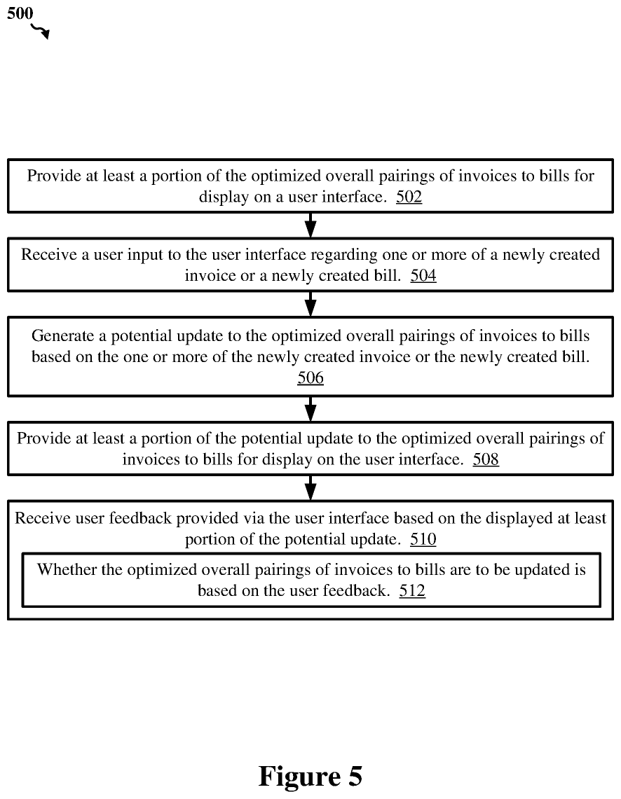

FIG. 5 shows an illustrative flow chart depicting an example operation 500 for interacting with a user regarding pairings of invoices to bills, according to some implementations. The operation 500 may be performed by the system 100, which may be remote or local to the user. At 502, the system 100 provides at least a portion of the optimized overall pairings of invoices to bills for display on a user interface (such as a GUI). For example, at least a portion of the one-to-one pairings of bills and invoices selected by the matching optimization model 160 (such as by executing the Hungarian algorithm) may be provided for display to the user. If the user is local, the interface 110 may include a display and other input/output means in order to display the pairings and receive user feedback. If the user is remote, the interface 110 may include a wired or wireless interface to transmit and indication of the pairings to a user device for display and for receiving user feedback.

In some implementations, the pairings may be displayed each time an invoice is created or a bill is uploaded. At 504, the system 100 receives a user input to the user interface regarding one or more of a newly created invoice or a newly created bill. To note, while an order of blocks 502 and 504 are depicted for clarity, the blocks may be performed in any order or at the same time. For example, the pairings may be displayed in response to receiving information regarding a new invoice being created or a new bill being uploaded or otherwise created. In some other implementations, the pairings may be displayed based on a user request (such as a user opening a tab or another portion of the service via a GUI) without receiving a user input or other information regarding a new bill or invoice.

As noted herein, a new bill or invoice may cause the system 100 to attempt to update the pairings to include the new bill or invoice. At 506, the system 100 generates a potential update to the optimized overall pairings of invoices to bills based on the one or more of the newly created invoice or the newly created bill. For example, if a new invoice is created, new potential pairs are to exist between the new invoice and the outstanding bills. The system 100 may obtain the invoice information regarding the new invoice, and the system 100 (such as the ML model 150) may calculate matching scores for the new potential pairs. In some implementations, the system 100 may recalculate matching scores for all potential pairs based on the new invoice (or new bill) being created. The system 100 (such as the matching optimization model 160) may then execute the Hungarian algorithm or other suitable matching models to generate the potentially new optimized overall pairings (which may include one or more different pairs than the original optimized overall pairings).

At 508, the system 100 may provide at least a portion of the potential update to the optimized overall pairings of invoices to bills for display on the user interface. For example, the system 100 may provide an indication to a remote user device (if the user is remote) or to a local GUI (if the user is local) of the different pairs between the new overall pairings and the original overall pairings as a result of the new invoice or new bill. In another example, the system 100 may provide an indication of all pairs of the new overall pairings (through which the user may scroll or otherwise look through the pairs). In yet another example, the system 100 may provide an indication of one or more pairs with the lowest matching score, indicating the pairs which are associated with the lowest confidence for pairing.

At 510, the system 100 receives user feedback provided via the user interface based on the displayed at least portion of the potential update. Whether the system 100 is to update the optimized overall pairings of invoices to bills is based on the user feedback (512). For example, the user may indicate via a GUI to reject the potential update. As a result, the system 100 may retain the original overall pairings for use in automating bill payments and optimizing cash flow. In another example, the user may indicate one or more of the new pairs in the potential update that are to be rejected. As a result, the system 100 may update the ML model 150 or otherwise generate new matching scores. Additionally or alternatively, the system 100 (such as the matching optimization model 160) may again execute the Hungarian algorithm or another suitable matching model with the indicated pairs being excluded from the final selection of pairs.

In some implementations, the user feedback may include a user indication of different invoice to bill pairs to be included in the optimized overall pairings. For example, the user may use a GUI of the user device or of the system 100 to adjust a pair so that the invoice is to be paired with a different bill and the bill is to be paired with a different invoice. The two new pairs are thus to be included in the new overall pairings to be used to automate bill payment and optimize cash flow. As a result, the system 100 (such as the matching optimization model 160) may again execute the Hungarian algorithm or another suitable matching model with the user matched bills and invoices excluded from the table or otherwise excluded from the matching problem (and thus the user matched pairs included in the final overall pairings to be used). As noted above, the system 100 may perform various operations in response to user input or feedback to update the pairings, thus continually attempting to optimize the pairings used for automated bill payment and cash flow optimization. While some example user feedback and input are disclosed for clarity in explaining some aspects of the present disclosure, other user feedback or input may be used and are not excluded from the present disclosure. Similarly, while some system operations that may be performed in response to user feedback or input are disclosed, other operations may be performed and are not excluded from the present disclosure.

As noted above, a user experience (UX) may be used to engage with a user regarding the outstanding invoices, the outstanding bills, the current pairings, potentially new pairings, or for adding new invoices or bills. In particular, a user interface (such as a GUI) may be used to interact with the user to allow the user to create new invoices, update the pairings, or otherwise provide user input or feedback regarding the operations performed by the system 100 to generate the pairings used for cash flow optimization. FIGS. 6A-6C shows an example GUI 600 that may be used to interact with the user regarding the pairings, invoices, and bills used for the cash flow optimization operations. To note, while FIGS. 6A-6C shows simplified example layouts of a GUI, the GUI may be in any suitable layout with additional or less information. As such, the present disclosure is not limited to the examples provided in FIGS. 6A-6C.

FIG. 6A shows an example GUI 600, according to some implementations. The GUI 600 includes a display of the current invoice to bill pairings 602. The invoice to bill pairings 602 includes a list of bills 1-m 604 and a list of invoices 1-n 606. The box 608 shows a linkage between bills 604 and invoices 606 to indicate the current one-to-one pairs. For example, bill 1 is paired with invoice n, and bill 2 is paired with invoice 2. To note, n and m may be any suitable integers and may or may not equal each other. In some implementations, the GUI 600 may be able to display the entirety of the pairings 602. In some other implementations, all of the pairings 602 may not fit in the GUI 600. While not depicted in FIG. 6A, the GUI 600 may include a vertical slider or other means for the user to scroll through the entirety of the invoice to bill pairings 602. The lists of bills and invoices may be ordered in any suitable order. For example, the list 604 may list bills from earliest due date to latest due date. In another example, the list 604 may list bills from largest amount to smallest amount. The invoices may be ordered in a similar manner in list 606.

In some implementations, the user may be able to adjust the user pairings 602 by interacting with box 608. For example, the user may use a cursor (as displayed), a touch input, or other means to delete an existing arrow, draw a new arrow, or change the terminals of an existing arrow in order to indicate one or more new pairs to be used. While not depicted in the GUI 600, the pairings 602 may be associated with a submit button or other means to indicate that the user has intentionally updated the pairings. For example, after the user draws a new arrow or otherwise updates the arrows, a pop-up window or other notification may occur on the GUI 600 asking the user to confirm the adjustments. The notification may include the adjustments to be made (such as the pairs being amended, pairs being added, or pairs being removed). The user may provide an input to accept or reject the changes. Such user input may be used to adjust the pairings used by the system (including attempting to generate potential updates to the pairings). For example, a change to a pair by the user may cause one or more other pairs to be adjusted by the system 100. Such potential changes may be displayed in the invoice to bill pairings 602. The user may have the opportunity to accept or decline the potential changes or otherwise indicate further adjustments to be made. In this manner, the user is able to provide input to the final pairings to be used as he or she sees fit.

In some implementations, the GUI 600 also includes a bill or invoice preview 610. For example, the user may use the cursor (or other user inputs) to select one or more bills or one or more invoices from lists 604 and 606. The selected bills or invoices may be previewed in the preview 610. A preview may be any suitable preview. For example, a preview may be an image of the bill or invoice as its received from an institution or sent to a customer. In another example, the preview may be a summary of the bill information or invoice information (such as the bill amount and bill due date, as well as possibly the institution providing the bill or for what services). The preview 610 may include concurrent previews of a plurality of bills or invoices or may include one bill or invoice at a time. For example, the preview 610 may preview the bill and invoice of a pair if either the bill or invoice is selected for preview. To note, the preview 610 may be included in the GUI 600 in any suitable manner. For example, the preview 610 may be on a separate page of a service provided via a web portal, may be a pop-up window that appears when one or more bills or invoices are selected, etc.

In some implementations, the GUI 600 further includes a new bill or invoice generator 612. While not shown, the generator 612 may include an option to scan or otherwise upload a bill (such as via an image of the bill, a scanner to scan a paper bill, or in any other suitable manner of uploading the bill). The generator 612 may include fields 614 that are to be filled in by the user in order to generate a new invoice or bill. For example, in generating a new invoice, the user may use fields 614 to provide invoice information, such as the customer, customer address or contact information, the invoice amount, services provided, date of services provided, and so on. Once the user has completed filling out the invoice information, the user may press the submit button 616 in order for the new invoice (or bill) to be generated for the system 100. As noted above, when a new invoice or bill is created, the system 100 may update the invoice to bill pairings. The update to the pairings may be displayed in the pairings 602. In some implementations, the GUI 600 may provide a summary of the largest changes to the pairings based on the newly created bill or invoice (such as the pairings associated with the largest amounts, the closest due dates, etc. that are to be adjusted based on the newly created invoice or bill). The summary may be provided in a pop-up window or as part of the pairings 602 (such as by highlighting the new pairings with boldened arrows or otherwise being indicated). Payment of one or more bills may be automated based on the new pairings. Other example means of showing the new pairings and automated payment of bills based on the pairings are shown in FIGS. 6B-6C.

FIG. 6B shows another example of the GUI 600, according to some implementations. The GUI 600 still includes an invoice to bill pairings 602, a bill or invoice preview 610, and a new bill or invoice generator 612. The pairings 602 includes a different layout of indicating one-to-one pairs of invoices and bills. For example, bill 1 is beside invoice n to indicate that they are a pair. Similarly, bill 2 is paired with invoice 2, and bill j is paired with invoice 1. In the example, bill m is not paired with an invoice. As such, no invoice in list 606 is beside bill m in list 604. As shown, the user uses the cursor to select bill 1, and a bill 1 preview 618 appears in the preview 610. If the bills are ordered in a specific manner (such as based on due dates), the invoices may be ordered based on the pairings to the ordered bills. Conversely, if the invoices are ordered in a specific manner (such as based on collection dates), the bills may be ordered based on the pairings to the ordered invoices.

The GUI 600 also includes an automated payment indicator 620 to indicate which bill payments are automated. In some implementations, the user may indicate that one or more bills are not to have their payments automated. The indicator 620 may indicate which bill payments are to be automated. The user may select one or more of them in order to prevent the payment from being automated. Conversely, the indicator 620 may be used to indicate which bill payments are not automated (with the majority of bill payments to be automated). In this manner, the user may be apprised of which bill payments are to be manually handled. For example, since bill m is not paired to an invoice, the indicator 620 may indicate that payment is not automated. Notifications of upcoming non-automated bill payments may be provided by the GUI 600 to the user as the bill due date approaches for each. For example, a week, three days, and one day before a bill payment is due, the GUI 600 may provide a notification to the user of the specific bill payment due.

As compared to the user adjusting the arrows in FIG. 6A to adjust the pairings, the user may adjust which invoice and which bill align with each other in order to adjust the pairings. For example, the user may use the cursor or another user input to drag and drop an invoice or bill to a different position in the list 604 or 606. For example, if bill m is to be paired with invoice n, the user may drag bill m to the top position in list 604. In this manner, bill 1 and bill m may switch positions in the list 604. As described with reference to FIG. 6A, a pop-up window or other notification means may be used to indicate the changes made and for the user to verify the changes being made to the pairings. The pairings 602 may then display any potential changes to the pairings based on the user input (such as after generating new matching scores and/or executing the Hungarian algorithm). In some implementations, updated pairings may be displayed concurrently with the original pairings in order for the user to be able to compare (such as depicted in FIG. 6C).

FIG. 6C shows another example of the GUI 600, according to some implementations. Similar to FIG. 6B, the GUI 600 includes the pairings 602, the preview 610, and the generator 612. In addition, the GUI 600 in FIG. 6C includes the updated pairings 622. For example, as the pairings 602 are adjusted by the user or a new invoice or bill is generated (via the generator 612), a potential update to the pairings may be generated by the system 100. The potential update may be displayed in the updated pairings 622, which includes a bill list 624 (similar to bill list 604) and an invoice list 626 (similar to invoice list 606). The pairings 622 shows any updated pairs based on the different alignments of bills and invoices in the lists 624 and 626. For example, bill 1 is originally paired to invoice n. The system 100 determines a potential update that bill 1 is to be paired to invoice k (which may be a new invoice created by the user or may be an existing invoice that was or was not paired to a different bill). In the example, bill m is now paired with invoice 1 (which is no longer paired with bill j). In some implementations, the updated pairings 622 may show all potential pairs (similar to pairings 602). In some other implementations, the updated pairings 622 may only show the potential pairs impacted by the potential update.

Through the inclusion of updated pairings 622 in the GUI 600, the user may have a side by side view of the original pairings and the updated pairings in order to quickly notice changes in the pairings as generated by the system 100. In some implementations, the GUI 600 may include a feedback section 628 for the user to provide feedback regarding the updated pairings 622. For example, the feedback section 628 may include check boxes for the user to indicate one or more pairs of the updated pairings 622 to be rejected (such as by selecting the box beside the alignment of bill 1 and invoice k). Conversely, the check boxes may be used to indicate one or more pairs of the updated pairings 622 that are desirable. To note, while an example of feedback is depicted as check boxes, feedback may be provided in any suitable manner. For example, the user may drag and drop one or more invoices or one or more bills in the updated pairings 622 to cause different pairs to be used. In another example, a user may select pairs from the pairings 602 and from the pairings 622 to indicate which original and which new pairs are to be used in the final pairings. In yet another example, the user may have the ability to select either the totality of the original pairings 602 or the updated pairings 622 as to be used. As such, user input and feedback is not limited to the examples provided, which are examples used exclusively for describing aspects of the present disclosure. For example, while not depicted in the GUI 600 in FIGS. 6A-6C, in some implementations, the user interface may display matching scores generated by the system 100. For example, before the pairs are even selected for use, the system 100 may provide an indication of a top number of matching scores and the associated invoices for one or more bills. In this manner, the user may select a matching score for one or more of the bills in order to indicate a pair to be used in the final selection of pairs. In the example of GUI 600, instead of displaying the pairings 602, the GUI 600 may display a list of matching scores in any suitable manner to allow user selection. User input may thus be the selection of matching scores in order to generate the pairings to be displayed in pairings 602. Once the final pairings are determined (such as based on the user feedback or input to require certain pairs from being included or from being excluded, based on user feedback or input accepting changes to the pairings based on a new invoice or bill, based on user feedback or inputs selecting one or more matching scores to select one or more pairs, based on other types of user feedback or input, or simply based on the pairings generated by the system 100 in generating the matching score and executing the matching optimization model based on the matching scores), the system 100 may continue with automating bill payments and optimizing cash flow based on the final pairings.

Referring back to FIG. 2, at 220, the system 100 generates instructions to automatically pay the one or more bills based on the pairings. An automatic payment of each bill of the one or more bills is based on a collection on the paired invoice for the bill (222). In some implementations, a bill is not paid until payment on the invoice is received or processed. To determine if an invoice is collected, a user may indicate such via a GUI, or the system 100 may receive an indication from a bank or other financial institution that payment was received. For example, the system 100 may connect to one or more financial institutions each night to determine if any payments are received. Alternatively, a notification of payment may be pushed to the system 100 by the financial institution. In response to the system 100 receiving notice that an invoice is collected, the system 100 may cause the paired bill to be paid. In some implementations, the bill payment scheduler 170 may automatically generate instructions to pay each bill and have the instructions stored (such as in the database 120) until notification of an invoice being collected is received. Once a notification is received, the generated instructions for the bill paired to the collected invoice may be transmitted to a financial institution responsible for paying the bill (such as to a third party payment processor). The instructions may be computer readable instructions that are to be provided to an application programming interface (API) of the payment service that includes the required information (such as payee, payor, funds source, amount, future payment date, etc.) to initiate payment of the bill. In some other implementations, instead of generating instructions before the bill is to be paid, the bill payment instructions may be generated in response to receiving a notification that the paired invoice is collected.

Any instructions to pay bills associated with collected invoices may be transmitted nightly. As such, bills may be batch processed according to which invoices are collected daily. To note, though, processing of payments may be performed at any frequency or even on demand, and the processing of payments is not limited to daily or nightly processing. In some implementations, the user may indicate that if payment for an invoice is not received, the system 100 is to automatically pay the bill without collection of the invoice (such as to prevent late payment fees). Not collecting to trigger payment of a bill may also be used as feedback to be used for future selections of pairings (such as reducing a collection probability for a customer, reducing the matching score associated with the type of invoice, etc.). For example, such non-collection may be considered a rejection of the pairing that may be used as a label for supervised learning of the ML model 150. Similarly, collected invoices and paid bills without issue may also be used as labels for supervised learning of the ML model 150. In addition, if an invoice is not collected and a bill due date approaches, a user may be notified (such as via a GUI 600) that the bill is coming due without the paired invoice being collected. In this manner, the user may manually pay the bill or remind the customer that payment is due on the invoice. Additionally or alternatively, the system 100 may be configured to automatically send a reminder to the customer (such as an email, text message, automated phone call, etc.) that an invoice is outstanding.

The collected invoices and paid bills may be removed from the pairings in order to keep the group of bills and group of invoices to those still outstanding. In some implementations, the pairings may be updated as new invoices or bills are received and/or as existing bills are paid. For example, after batch processing of one or more bill payments, the system 100 may execute the Hungarian algorithm to generate new optimized pairings. In some other implementations, the pairings may be adjusted only periodically or only after receiving one or more new invoices and/or bills (with collecting invoices or paying bills not affecting the existing pairings). In addition, the pairings may be adjusted based on user input or feedback for the pairings. As such, the database 120 may be updated as necessary with the new pairings in order to keep track of the current one-to-one pairs of bills to invoices being used for automated bill payment.

As described above, the system 100 (or another suitable system) may perform the operations of pairing bills and invoices in an optimum manner to manage payment of bills while optimizing cash flow. With the difference in amounts and dates to be minimized, changes in a bank account balance should be minimized to prevent large variations in cash flow. As noted above, the system 100 is expandable to any number of invoices and bills and is thus at scale that would be unmanageable by an individual or a team of individuals. In addition, through the use of ML technology and optimization means, the pairings may be more optimized than if based on manual selection of pairs of bills to invoices. The system 100 is also configured to allow user input to prevent the operations being performed to optimize cash flow form being a black box or otherwise obfuscated from the user, which may lead to higher user engagement and satisfaction in operation of the system.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, and “one or more of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, while the figures and description depict an order of operations to be performed in performing aspects of the present disclosure, one or more operations may be performed in any order or concurrently to perform the described aspects of the disclosure. In addition, or to the alternative, a depicted operation may be split into multiple operations, or multiple operations that are depicted may be combined into a single operation. Thus, the claims are not intended to be limited to the implementations shown herein but are to be accorded the widest scope consistent with this disclosure, the principles, and the novel features disclosed herein.

1. A computer-implemented method for cash flow optimization for an entity by a computing system, the computer-implemented method comprising:
obtaining, by an interface of the computing system, a bill information for an entity regarding a plurality of bills to be paid by the entity, wherein the bill information includes:
a bill amount to be paid to a party by the entity of each of the plurality of bills; and
a bill due date of when the bill amount is to be paid to the party by the entity of each of the plurality of bills;
obtaining, by the interface, an invoice information for the entity regarding a plurality of invoices to be collected by the entity, wherein the invoice information includes:
an invoice amount to be collected from another party by the entity of each of the plurality of invoices; and
an invoice collection date of when the invoice amount is to be collected from the other party by the entity of each of the plurality of invoices;
pairing one or more bills of the plurality of bills to one or more invoices of the plurality of invoices, wherein pairing the one or more bills includes:
receiving, by a machine learning (ML) classification model of the computing system:
the bill information regarding the plurality of bills; and
the invoice information regarding the plurality of invoices; and
for each bill of the one or more bills:
generating one or more potential pairs of the bill to an invoice from the plurality of invoices;
for each potential pair of the one or more potential pairs, calculating, by the ML classification model, a matching score associated with the potential pair based on the bill information of the bill and the invoice information of the invoice, wherein the ML classification model is previously trained via supervised learning based on received user feedback to previously generated potential pairings indicated to a user, wherein the user feedback is used as labels during supervised learning of the ML classification model;
identifying a subset of potential pairs of the one or more potential pairs associated with a threshold matching score; and
selecting, by a matching optimization model of the computing system, a pair of a paired invoice to the bill from the subset of potential pairs; and
generating instructions to automatically pay the one or more bills based on the pairing, wherein an automatic payment of each bill of the one or more bills is based on a collection on the paired invoice for the bill.

2. The method of claim 1, wherein calculating the matching score based on the bill information of the bill and the invoice information of the invoice includes calculating the matching score based on a combination of:
a difference in the bill amount of the bill and the invoice amount of the invoice; and
a difference in the bill due date of the bill and the invoice collection date of the invoice.

3. The method of claim 2, wherein the invoice collection date of the invoice is an invoice due date of the invoice.

4. The method of claim 2, wherein:
one or more of the bill information or the invoice information include additional information of one or more of:
an invoice payment probability;
a bill late payment fee; or
an invoice late payment fee; and
calculating the matching score by the ML classification model is also based on the additional information, wherein the additional information is received by the ML classification model as inputs.

5. The method of claim 1, further comprising:
indicating the pairings; and
receiving feedback to the pairings based on the indication, wherein selecting the pair of the paired invoice to the bill is based on the feedback.

6. The method of claim 5, wherein pairing the one or more bills includes:
generating, by the ML classification model, a matching score for each one-to-one pairing of the plurality of invoices to the plurality of bills.

7. The method of claim 6, wherein pairing the one or more bills includes:
optimizing, by the matching optimization model, the overall pairings of invoices to bills based on the matching scores generated by the ML classification model for all of the one-to-one pairings of the plurality of invoices to the plurality of bills.

8. The method of claim 7, wherein optimizing by the matching optimization model includes:
generating a table of invoices to bills, wherein each entry in the table includes a matching score associated with a unique one-to-one pairing of an invoice to a bill;
editing the table to have a same number of rows as a number of columns, wherein editing the table includes generating one of:
one or more dummy rows of the table to include a plurality of zero padding matching scores; or
one or more dummy columns of the table to include a plurality of zero padding matching scores; and
executing the Hungarian algorithm on the edited table to optimize overall pairings of invoices to bills.

9. The method of claim 8, further comprising:
providing at least a portion of the optimized overall pairings of invoices to bills for display on a user interface;
receiving a user input to the user interface regarding one or more of a newly created invoice or a newly created bill;
generating a potential update to the optimized overall pairings of invoices to bills based on the one or more of the newly created invoice or the newly created bill;
providing at least a portion of the potential update to the optimized overall pairings of invoices to bills for display on the user interface; and
receiving user feedback provided via the user interface based on the displayed at least portion of the potential update, wherein whether the optimized overall pairings of invoices to bills are to be updated is based on the user feedback.

10. The method of claim 9, wherein the user feedback includes a user indication of different invoice to bill pairs to be included in the optimized overall pairings.

11. A computing system for cash flow optimization for an entity, the computing system comprising:
one or more processors; and
a memory storing instructions that, when executed by the one or more processors, causes the computing system to perform operations comprising:
obtaining, by an interface of the computing system, a bill information for an entity regarding a plurality of bills to be paid by the entity, wherein the bill information includes:
a bill amount to be paid to a party by the entity of each of the plurality of bills; and
a bill due date of when the bill amount is to be paid to the party by the entity of each of the plurality of bills;
obtaining, by the interface, an invoice information for the entity regarding a plurality of invoices to be collected by the entity, wherein the invoice information includes:
an invoice amount to be collected from another party by the entity of each of the plurality of invoices; and
an invoice collection date of when the invoice amount is to be collected from the other party by the entity of each of the plurality of invoices;
pairing one or more bills of the plurality of bills to one or more invoices of the plurality of invoices, wherein pairing the one or more bills includes:
receiving, by a machine learning (ML) classification model of the computing system:
the bill information regarding the plurality of bills; and
the invoice information regarding the plurality of invoices; and
for each bill of the one or more bills:
generating one or more potential pairs of the bill to an invoice from the plurality of invoices;
for each potential pair of the one or more potential pairs, calculating, by the ML classification model, a matching score associated with the potential pair based on the bill information of the bill and the invoice information of the invoice, wherein the ML classification model is previously trained via supervised learning based on received user feedback to previously generated potential pairings indicated to a user, wherein the user feedback is used as labels during supervised learning of the ML classification model;
identifying a subset of potential pairs of the one or more potential pairs associated with a threshold matching score; and
selecting, by a matching optimization model of the computing system, a pair of a paired invoice to the bill from the subset of potential pairs; and
generating instructions to automatically pay the one or more bills based on the pairing, wherein an automatic payment of each bill of the one or more bills is based on a collection on the paired invoice for the bill.

12. The system of claim 11, wherein calculating the matching score based on the bill information of the bill and the invoice information of the invoice includes calculating the matching score based on a combination of:
a difference in the bill amount of the bill and the invoice amount of the invoice; and
a difference in the bill due date of the bill and the invoice collection date of the invoice.

13. The system of claim 12, wherein the invoice collection date of the invoice is an invoice due date of the invoice.

14. The system of claim 12, wherein:
one or more of the bill information or the invoice information include additional information of one or more of:
an invoice payment probability;
a bill late payment fee; or
an invoice late payment fee; and
calculating the matching score by the ML classification model is also based on the additional information, wherein the additional information is received by the ML classification model as inputs.

15. The system of claim 11, wherein the operations further comprise:
indicating the pairings; and
receiving feedback to the pairings based on the indication, wherein selecting the pair of the paired invoice to the bill is based on the feedback.

16. The system of claim 15, wherein pairing the one or more bills includes:
generating, by the ML classification model, a matching score for each one-to-one pairing of the plurality of invoices to the plurality of bills.

17. The system of claim 16, wherein pairing the one or more bills includes:
optimizing, by the matching optimization model, the overall pairings of invoices to bills based on the matching scores generated by the ML classification model for all of the one-to-one pairings of the plurality of invoices to the plurality of bills.

18. The system of claim 17, wherein optimizing by the matching optimization model includes:
generating a table of invoices to bills, wherein each entry in the table includes a matching score associated with a unique one-to-one pairing of an invoice to a bill;
editing the table to have a same number of rows as a number of columns, wherein editing the table includes generating one of:
one or more dummy rows of the table to include a plurality of zero padding matching scores; or
one or more dummy columns of the table to include a plurality of zero padding matching scores; and
executing the Hungarian algorithm on the edited table to optimize overall pairings of invoices to bills.

19. The system of claim 18, further comprising an interface coupled to the one or more processors, wherein the operations further comprise:
providing, by the interface, at least a portion of the optimized overall pairings of invoices to bills for display on a user interface;
receiving, by the interface, a user input to the user interface regarding one or more of a newly created invoice or a newly created bill;
generating a potential update to the optimized overall pairings of invoices to bills based on the one or more of the newly created invoice or the newly created bill;
providing, by the interface, at least a portion of the potential update to the optimized overall pairings of invoices to bills for display on the user interface; and
receiving, by the interface, user feedback provided via the user interface based on the displayed at least portion of the potential update, wherein whether the optimized overall pairings of invoices to bills are to be updated is based on the user feedback.

20. The system of claim 19, wherein the user feedback includes a user indication of different invoice to bill pairs to be included in the optimized overall pairings.
